(19) United States
(12) Patent Application Publication
(10) Pub. No.: US 2010/0161510 A1
(43) Pub. Date: Jun. 24, 2010

(54) METHOD AND COMPUTER-READABLE PROGRAM FOR ANALYZING VALUE AND RISK

(76) Inventor: Gunnar P. Nilsson, Lake Forest, IL (US)

Correspondence Address: ICE MILLER LLP, ONE AMERICAN SQUARE, SUITE 3100, INDIANAPOLIS, IN, 46282-0200, US

(21) Appl. No.: 12/645,126

(22) Filed: Dec. 22, 2009

Related U.S. Application Data
(60) Provisional application No. 61/139,992, filed on Dec. 22, 2008.

(51) Int. Cl. G06Q 40/00

(52) U.S. Cl. 705/36 R

(57) ABSTRACT

Methods and computer-readable programs for analyzing value and risk through the use of one or more computers are disclosed. According to one embodiment of the disclosure, a method for analyzing value and risk includes providing market capitalization data and book value data. The method further includes identifying value and risk items and ranking the identified value and risk items. The method includes determining the average rank for each item ranked. The method also includes determining the value of each item based on the combined average rank for each item and the difference between the market capitalization and the book value and displaying a portion of the rank information on the one or more computers.

### CROSS REFERENCE TO RELATED APPLICATION

This application claims the benefit of and incorporates by reference herein the disclosure of U.S. Ser. No. 61/139,992, filed Dec. 22, 2008.

### BACKGROUND

A company's “book value” can be determined from its balance sheet by subtracting the company's liabilities from the company's assets. Another name for book value is “ownership equity,” as a company's balance sheet reflects a position where a company's assets are equal to the sum of its liabilities and ownership equity.

A company's “market capitalization” can be determined by multiplying the number of shares of the company that are outstanding by the current price per share. There often is a gap (frequently a large gap) between a company's market capitalization and its book value. The tools and methods used to analyze this gap fail to provide accurate and complete information about the respective company. Similarly, the tools and methods used to analyze the valuation of market equity of non-publicly traded companies fail to provide accurate and complete information. Accordingly, there exists a need for tools and methods that can accurately and completely provide financial information about a company.

### SUMMARY

The present disclosure discloses a method and computer-readable program for analyzing value and risk through the use of one or more computers. One embodiment of a method of analyzing value and risk through the use of one or more computers includes providing market capitalization data and book value data to one or more computers. The method also includes identifying a first value list using the one or more computers, the first value list comprising one or more value items, ranking the value items of the first value list using the one or more computers, identifying a first risk list using the one or more computers, the first risk list comprising one or more risk items, ranking the risk items of the first risk list using the one or more computers, and determining the average rank for each of the value items of the first value list and the risk items of the first risk list using the one or more computers.

The method further includes identifying a second value list using the one or more computers, the second value list comprising one or more value items, ranking the value items of the second value list using the one or more computers, identifying a second risk list using the one or more computers, the second risk list comprising one or more risk items, ranking the risk items of the second risk list using the one or more computers, and determining the average rank for each of the value items of the second value list and the risk items of the second risk list using the one or more computers. The method also includes the steps of determining the combined average rank for each item ranked using the one or more computers, determining the value of each item ranked based on the combined average rank for each item and the difference between the market capitalization and the book value using one or more computers, and displaying at least a portion of the ranking information and the value of each item on the one or more computers.

In another embodiment of a method of analyzing value and risk through the use of one or more computers, the method includes providing predetermined weight data and capital data. The method also includes the steps of identifying a first value list using the one or more computers, the first value list comprising one or more value items, scoring the value items of the first value list using the one or more computers, identifying a first risk list using the one or more computers, the first risk list comprising one or more risk items, scoring the risk items of the first risk list using the one or more computers, and determining the average score for each of the value items of the first value list and the risk items of the first risk list using the one or more computers.

The method further includes the steps of identifying a second value list using the one or more computers, the second value list comprising one or more value items, scoring the value items of the second value list using the one or more computers, identifying a second risk list using the one or more computers, the second risk list comprising one or more risk items, scoring the risk items of the second risk list using the one or more computers, and determining the average score for each of the value items of the second value list and the risk items of the second risk list using the one or more computers. The method also includes the steps of determining the combined average score for each item scored using the one or more computers, determining the contribution to tangible capital by at least one scored item based on the predetermined weight data, a factor that is based on the combined average score of the at least one scored item, and the capital data of the company using the one or more computers, and displaying at least a portion of the score information on the one or more computers.

In an embodiment of a computer-readable program for analyzing value and risk, the code portions stored therein include a first executable portion for receiving predetermined weight data and tangible capital data and a second executable portion for identifying a first value list, the first value list comprising one or more value items, wherein the second executable portion is also configured for scoring the value items of the first value list, wherein the second executable portion is further configured for identifying a first risk list, the first risk list comprising one or more risk items, wherein the second executable portion is further configured for scoring the risk items of the first risk list, wherein the second executable portion is further configured for determining the average score for each of the value items of the first value list and the risk items of the first risk list. The code portions stored within the computer-readable program also include a third executable portion for identifying a second value list, the second value list comprising one or more value items, wherein the third executable portion is also configured for scoring the value items of the second value list, wherein the third executable portion is further configured for identifying a second risk list, the second risk list comprising one or more risk items, wherein the third executable portion is further configured for scoring the risk items of the second risk list, wherein the third executable portion is further configured for determining the average score for each of the value items of the second value list and the risk items of the second risk list.

The code portions within the computer-readable program further include a fourth executable portion for determining the combined average score for each item scored, a fifth executable portion for determining the contribution to tangible capital by at least one scored item based on the predetermined weight data, a factor that is based on the combined average score of the at least one scored item, and the capital data of the company, and a sixth executable portion for displaying at least a portion of the score information.

### BRIEF DESCRIPTION OF THE DRAWINGS

The features and advantages of this disclosure, and the manner of attaining them, will be more apparent and better understood by reference to the following descriptions of the disclosed method and computer-readable program, taken in conjunction with the accompanying drawings, wherein:

FIGS. 1a-1t show graphical user interfaces of a computer-readable program according to at least one embodiment of the present disclosure.

FIG. 2 shows a method for analyzing value and risk according to at least one embodiment of the present disclosure.

FIG. 3 shows a graphical user interface with the Identification tab selected in the computer-readable program of FIGS. 1a-1t.

FIG. 4 shows a graphical user interface with the Company Consolidation tab selected in the computer-readable program of FIGS. 1a-1t.

FIG. 5a shows a graphical user interface with the Final Consolidation tab selected in the computer-readable program of FIGS. 1a-1t.

FIG. 5b shows a graphical user interface including a graph based on the information of FIG. 5a.

FIG. 6 shows a graphical user interface with the Report tab selected in the computer-readable program of FIGS. 1a-1t.

FIG. 7 shows a graphical user interface with the Balance Report tab selected in the computer-readable program of FIGS. 1a-1t.

FIG. 8 shows a graphical user interface with the Gap Report tab selected in the computer-readable program of FIGS. 1a-1t.

FIG. 9 shows a graphical user interface with the Action Graphics tab selected in the computer-readable program of FIGS. 1a-1t.

FIG. 10 shows a graphical user interface with the Action Priorities tab selected in the computer-readable program of FIGS. 1a-1t.

FIG. 11 shows a graphical user interface with the Framework tab selected in the computer-readable program of FIGS. 1a-1t.

FIGS. 12a-12b show graphical user interfaces of P&L Deep Dive of the Framework tab in the computer-readable program of FIGS. 1a-1t.

FIG. 13 shows a method for analyzing value and risk according to at least one embodiment of the present disclosure.

FIG. 14 shows a graphical user interface of the Identification tab according to at least one embodiment of the present disclosure.

FIG. 15 shows a graphical user interface of the Company Consolidation tab according to at least one embodiment of the present disclosure.

FIG. 16 shows a graphical user interface of the Final Consolidation tab according to at least one embodiment of the present disclosure.

FIG. 17 shows a graphical user interface of the Valuation tab according to at least one embodiment of the present disclosure.

FIG. 18 illustrates the statements that are displayed in the Reports tab according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A Value & Risk Transformer (VRT) tool according to an embodiment of the present disclosure provides information on the value and risk of a company. In one embodiment of the present disclosure, the VRT tool identifies and quantifies sources of value and risk based on input and feedback from various individuals. In particular, as explained further below, the VRT tool can de-construct the difference between a company's current market capitalization and book value, and assign dollar values to soft assets, organizational opportunities, and risks, among other things. In another embodiment of the present disclosure, the VRT tool determines the valuation of market equity of a company based on input and feedback from various individuals. In particular, as explained further below, the VRT tool can determine the projected company valuation.

Reports generated by the VRT tool form a framework for corrective or opportunistic action by a company. In general, the use of a VRT tool may help users create an action plan for strengthening and growing value, while mitigating or minimizing risk. Customized action plans may be used to implement the results of a VRT tool. In any case, a VRT tool offers a company improved chances of success.

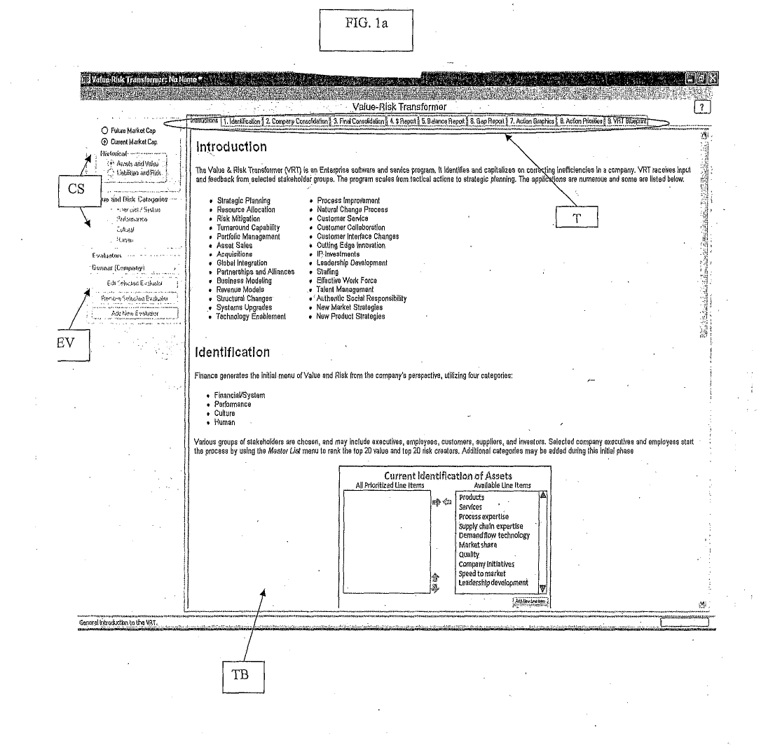

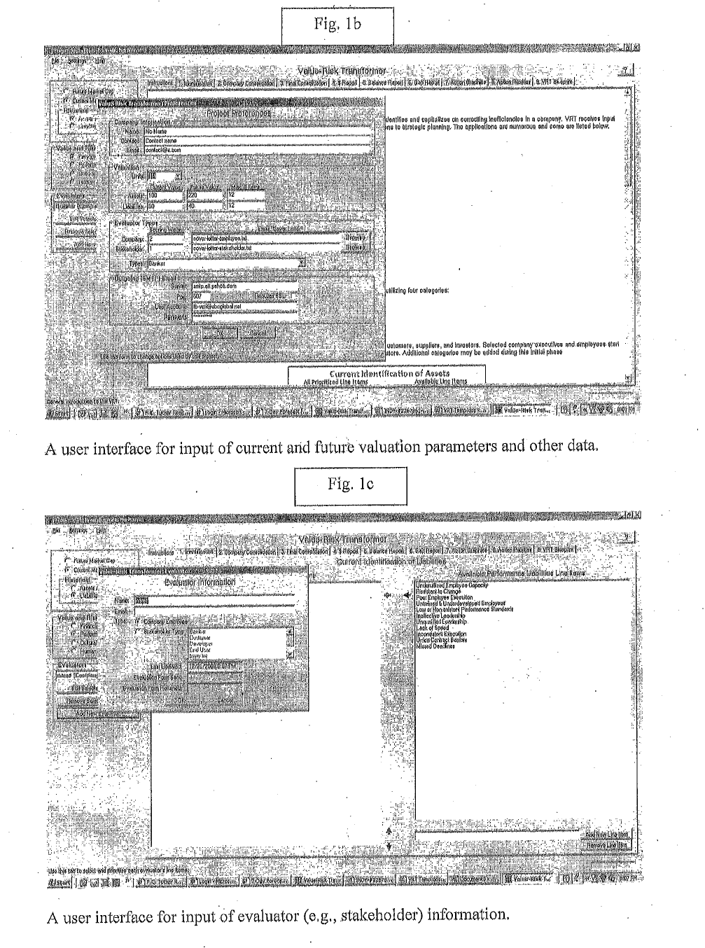

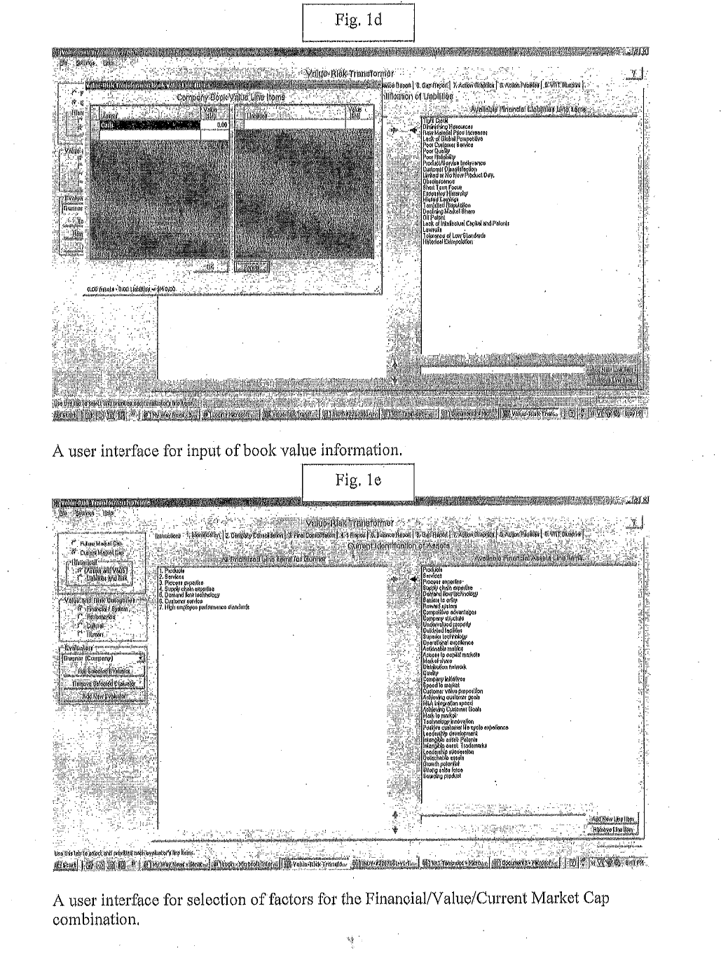

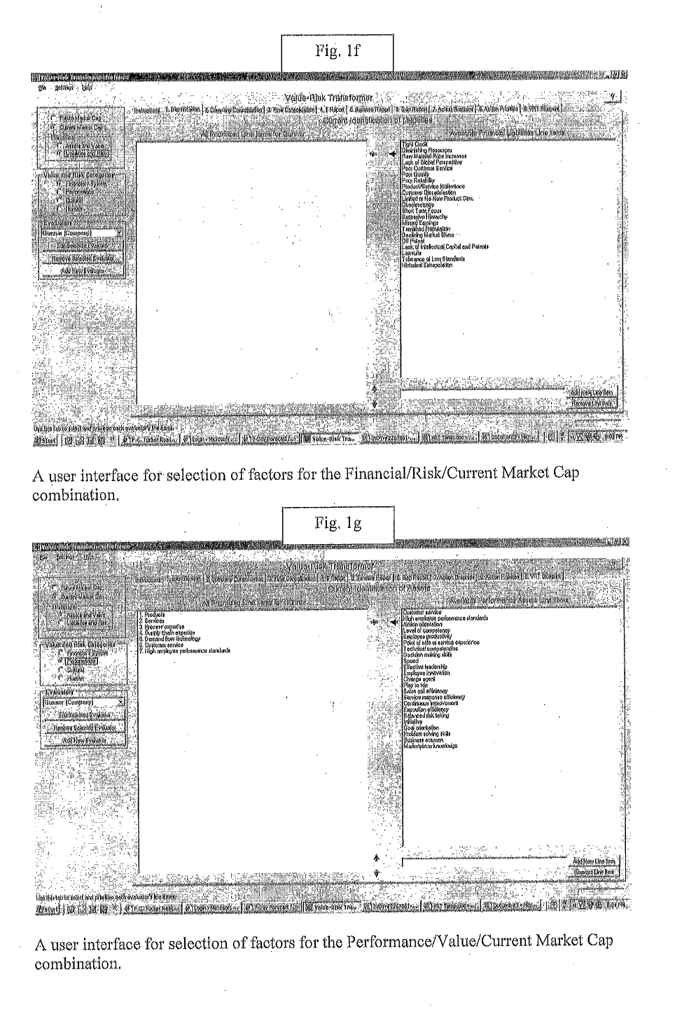

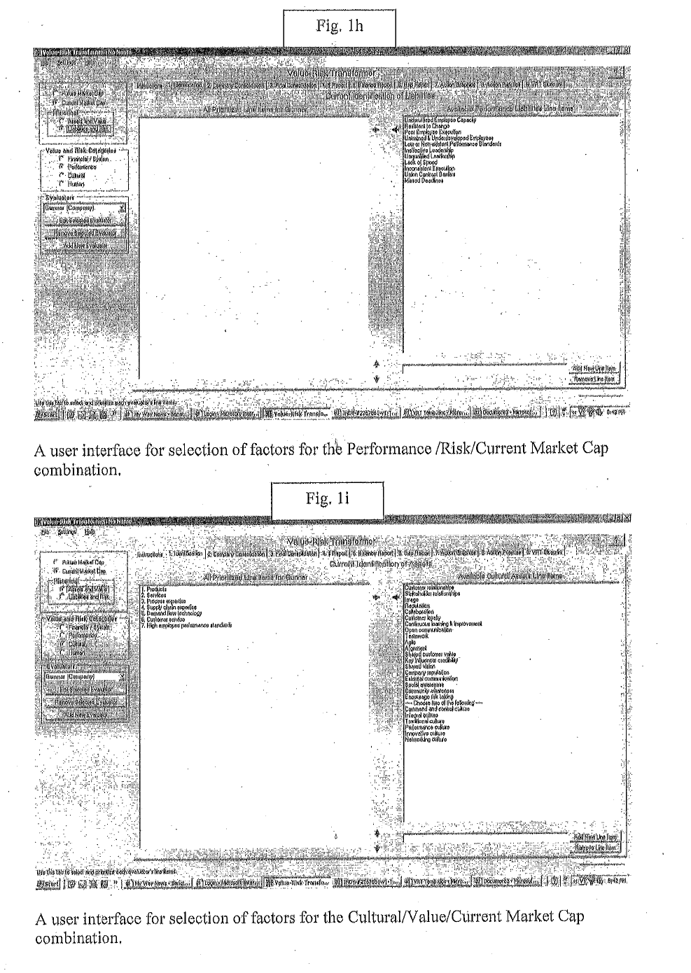

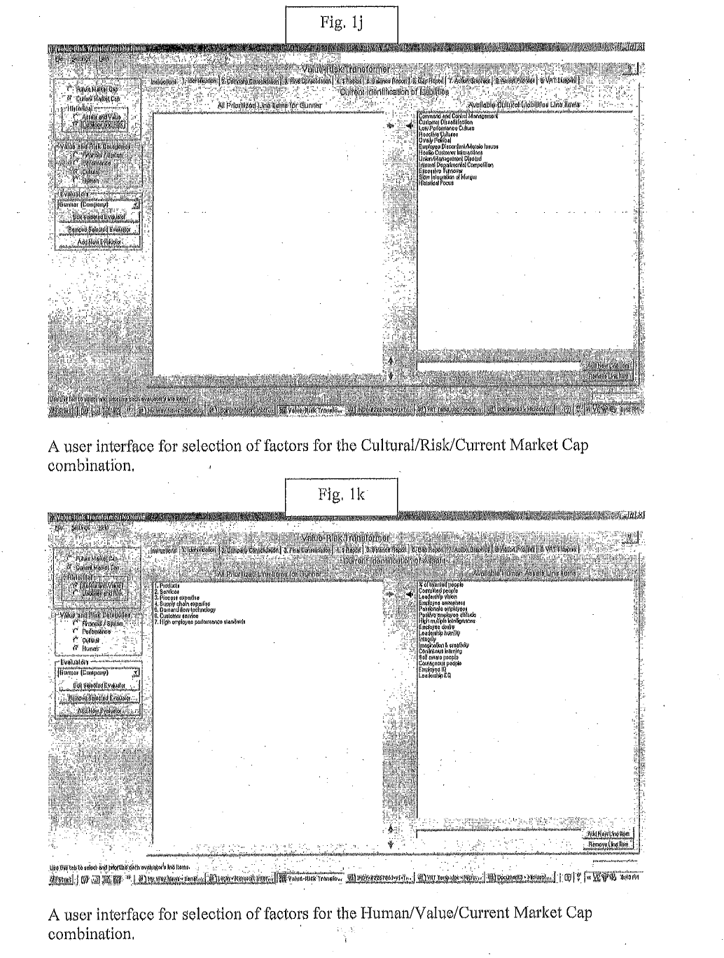

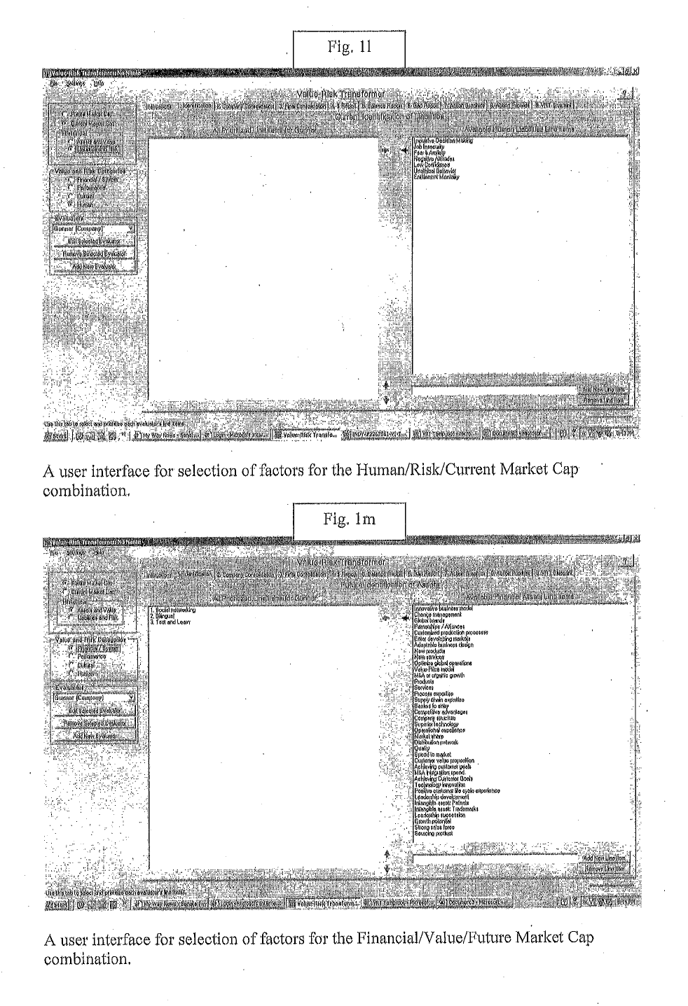

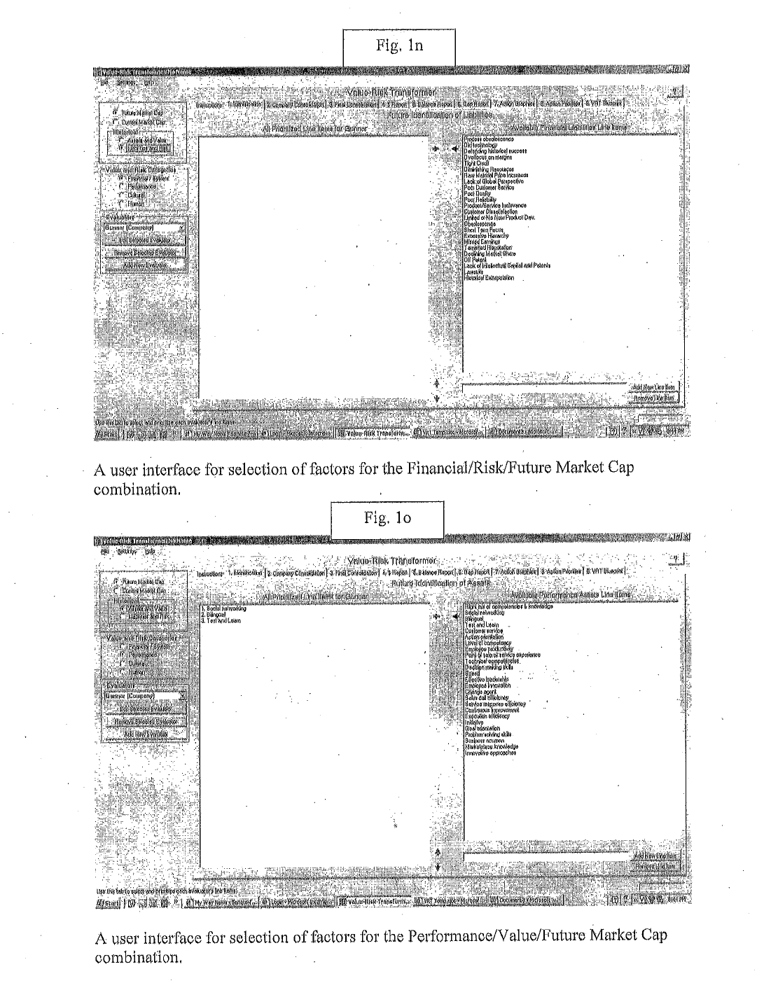

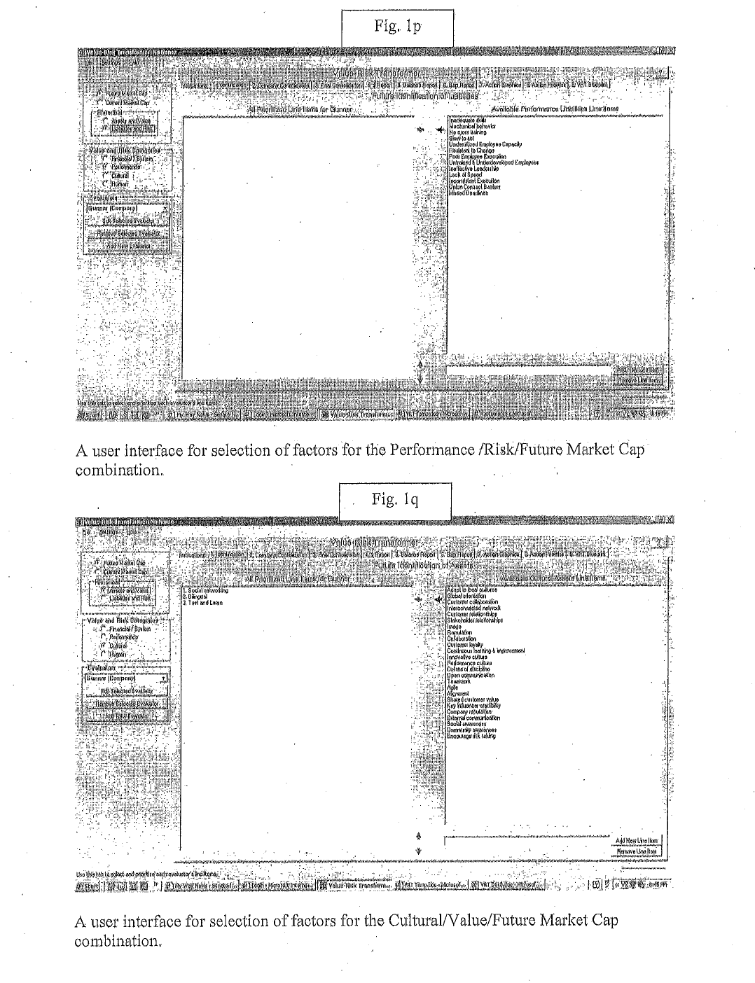

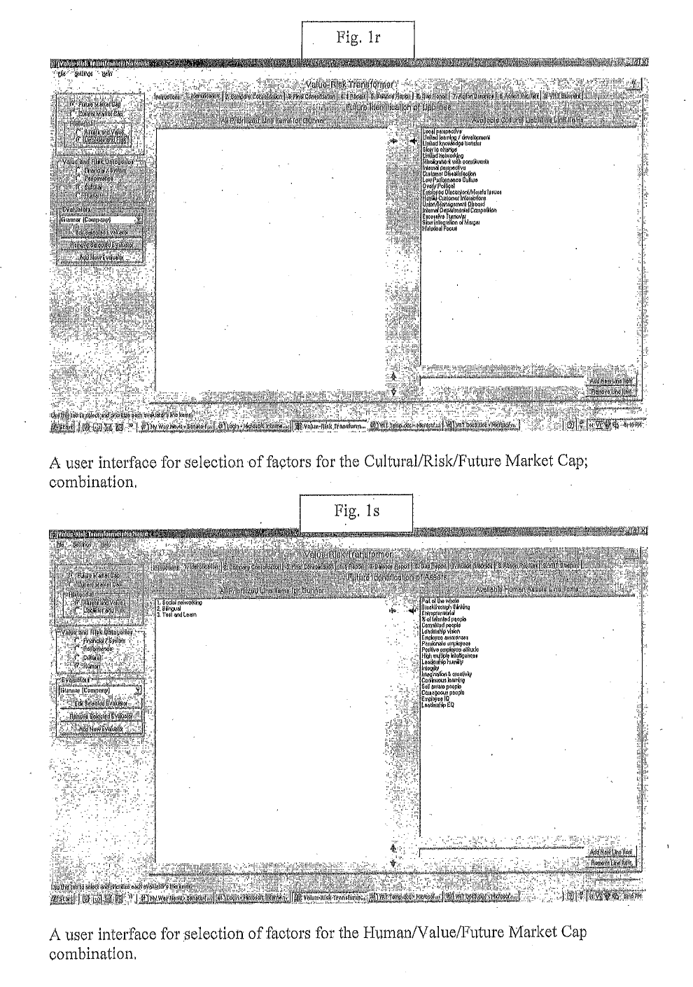

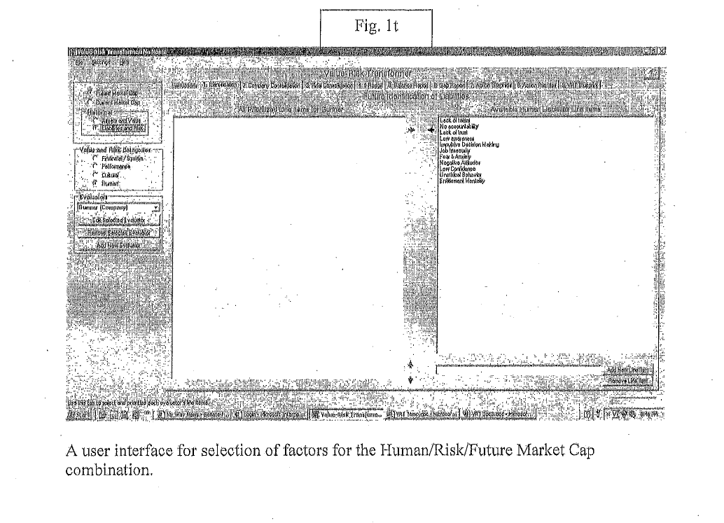

Each embodiment of the VRT tool is computer-implemented. FIG. 1a shows a graphical user interface of the VRT tool according to at least one embodiment of the present disclosure. As shown in FIG. 1a, the VRT tool includes various tabs T. Upon selecting one of the tabs T, the corresponding tab box TB is displayed. In FIG. 1a, for example, the Instructions tab is active and the corresponding data for instructions is displayed in the tab box TB. Typically, the Instructions tab includes a general discussion of the tool and a brief summary of the other sections or tabs, such as, for example, the “1. Identification” tab. Also, other information may be included in the Instructions tab box, such as detailed information that assists with using the tool. Typically, the Instructions tab is the default tab activated upon starting up the tool and, therefore, instructions data would be displayed initially. Of course, another tab may be the default tab when the tool is initially activated. In FIG. 1a, there are 10 tabs T shown. There may, of course, be more or less tabs. The tabs and information contained in the corresponding tab boxes will be described more fully below.

In FIG. 1a, the category section CS includes buttons for choosing between Current Market Capitalization, Future Market Capitalization, and optionally Valuation (not shown). Also, the category section CS includes a section called the “Historical” section with a choice between “Assets and Value” and “Liabilities and Risk.” In FIG. 1b, a graphical user interface of the VRT tool for inputting project parameters is shown. In FIG. 1a, there is also an “Evaluators” section EV that allows a user to select a profile, such as a name or company, and to add and remove evaluator profiles. FIG. 1c shows a graphical user interface of the VRT tool for inputting evaluator information. The selections made in the category section CS and evaluators section EV at least partially determine the information retrieved and presented for each tab and corresponding tab box. It should be noted that financial information regarding the company is inputted into the VRT tool, including book value and market value of the company. FIG. 1d shows a graphical user interface for inputting book value information. A graphical user interface for inputting market value or other company information may typically look like FIG. 1d.

FIGS. 1e-1t show exemplary graphical user interfaces for input of considerations from the 16 different combinations involving current market capitalization or future market capitalization available at the identification tab. The combinations include:

Financial/Value/Current Market Capitalization;

Financial/Risk/Current Market Capitalization;

Performance/Value/Current Market Capitalization;

Performance/Risk/Current Market Capitalization;

Cultural/Value/Current Market Capitalization;

Cultural/Risk/Current Market Capitalization;

Human/Value/Current Market Capitalization;

Human/Risk/Current Market Capitalization;

Financial/Value/Future Market Capitalization;

Financial/Risk/Future Market Capitalization;

Performance/Value/Future Market Capitalization;

Performance/Risk/Future Market Capitalization;

Cultural/Value/Future Market Capitalization;

Cultural/Risk/Future Market Capitalization;

Human/Value/Future Market Capitalization; and

Human/Risk/Future Market Capitalization.

The various combinations provide for an extremely comprehensive insight into a company. While FIGS. 1e-1t show some considerations or line items, it should be noted that additional considerations or line items may be added to or deleted from each page by use of the buttons on the bottom left of the page.

When either Current Market Capitalization or Future Market Capitalization are selected under category section CS, the VRT tool determines the sources of value and risk for a company and the degree to which each source effects market capitalization of the company. When Valuation is selected under category section CS, the VRT tool determines valuation of market equity of a company. Both situations are discussed below.

### Sources of Value and Risk

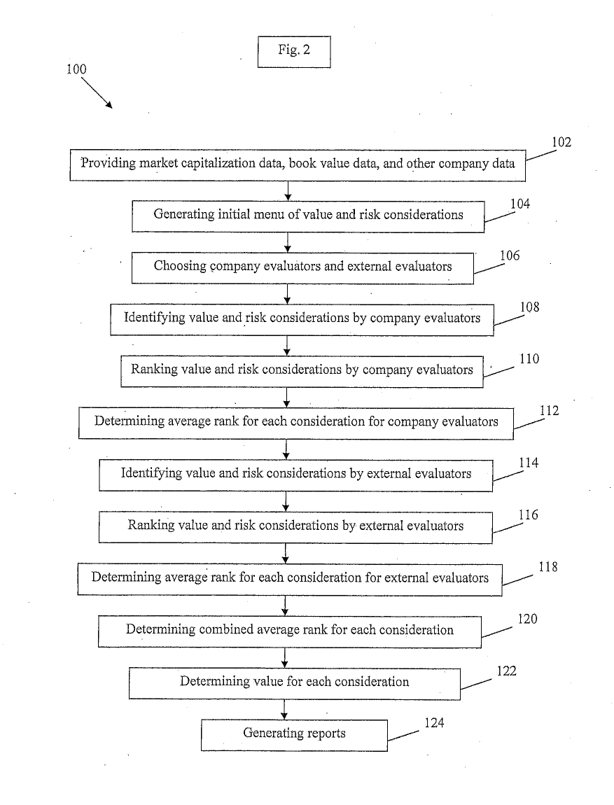

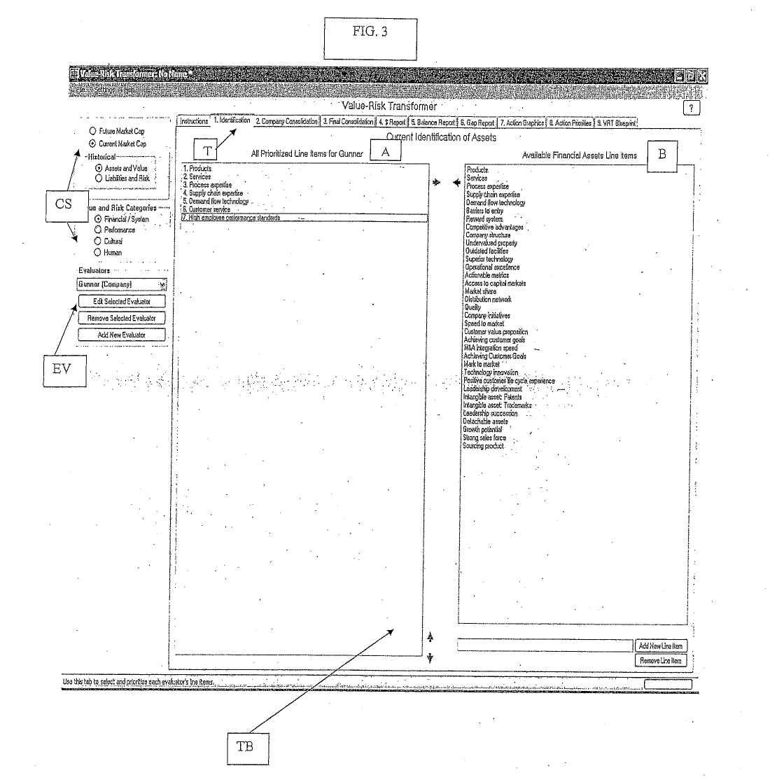

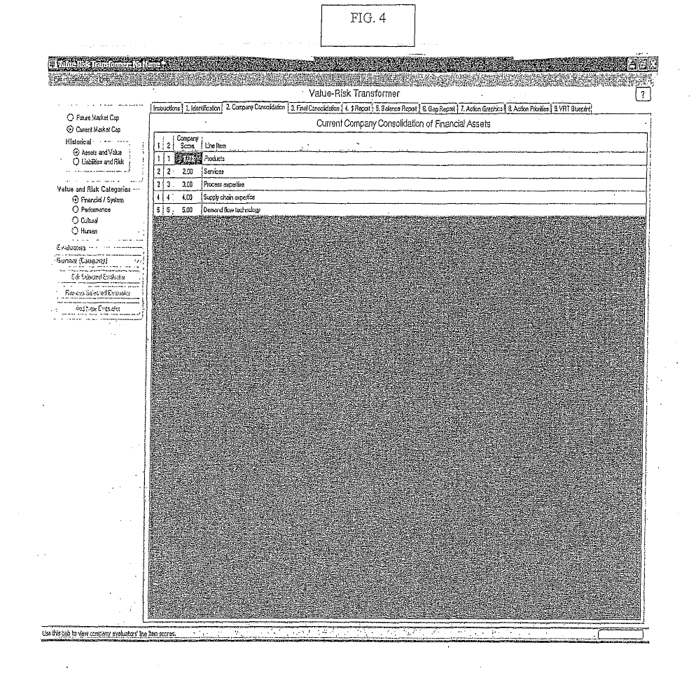

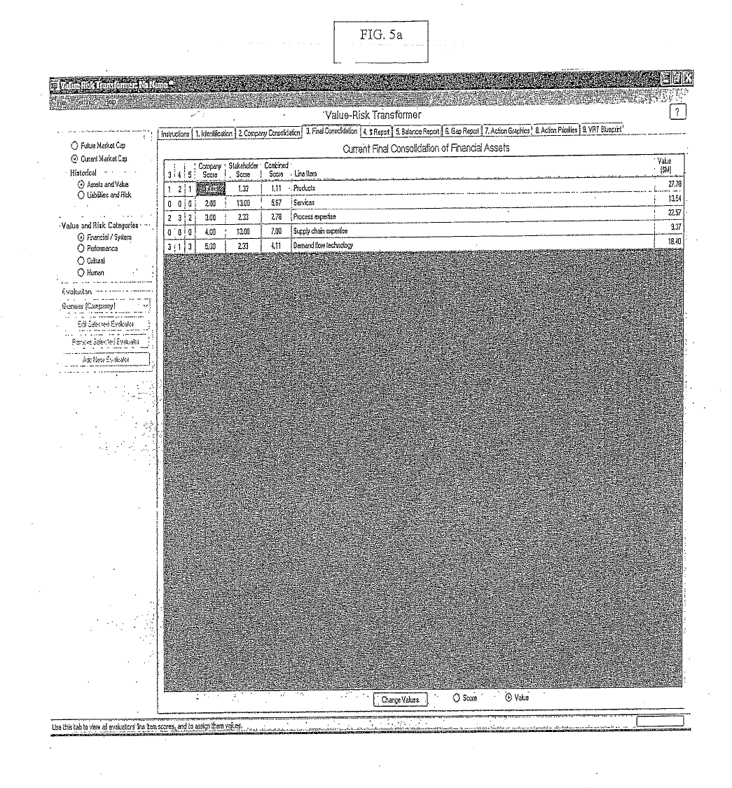

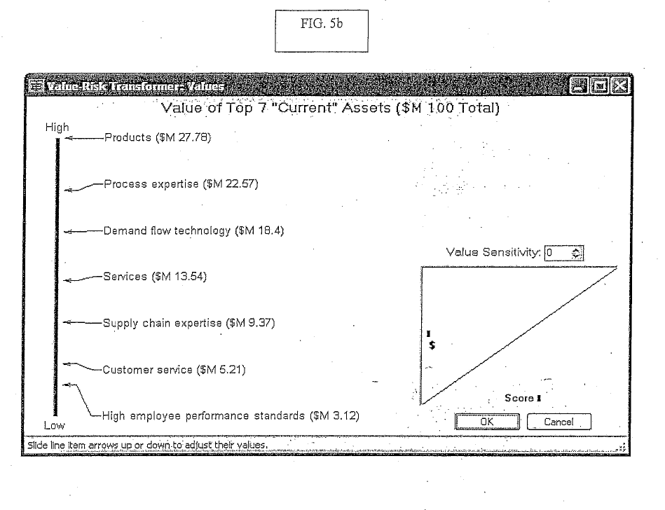

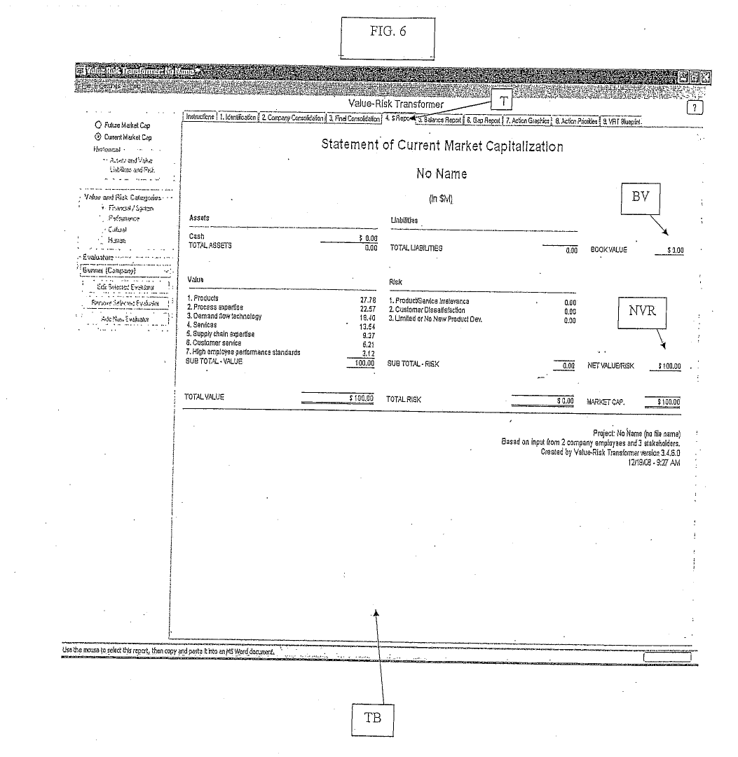

A VRT tool according to an embodiment of the present disclosure analyzes the gap between a company's market capitalization and its book value, through the analysis of certain value and risk considerations. In one embodiment of the present disclosure, a VRT tool is configured to perform the method for analyzing the gap between a company's market capitalization and its book value 100 shown in FIG. 2. As shown in FIG. 2, the method 100 includes providing market capitalization data, book value data, and other information of the company 102. As mentioned above, FIGS. 1b and 1d exemplify graphical user interfaces for inputting information on the company into the VRT tool. The next step of method 100 is generating an initial menu of value and risk considerations 104. According to the present disclosure, typically one or more user coordinators generates the initial menu of value and risk considerations drawn from four distinct yet interdependent categories: Financial/System, Performance, Culture, and Human. These four categories are described by the following:
1. Financial/System—Encompasses all aspects of company financial performance and results. It is the cumulative output of the company including products, services, processes, intangible assets, technology, earnings and market capitalization on the value side. Tight credit, missed earnings, poor quality, process breakdowns, lawsuits and recessions are examples of risk considerations.
2. Performance—This category focuses on the individual behaviors, performance, skills, and execution. Decisiveness, business acumen, speed, problem solving, high standards, effective leadership, change agent, risk taking and initiative are performance based value considerations. Resistance to change, ineffective leadership, low standards, and inconsistent execution are examples of risk considerations.
3. Culture—From a value perspective, this includes all aspects of the company culture including internal and external relationships, communication, team work, alignment, reputation and collaboration. Consistent dissatisfactions, morale issues, excessive turnover, and union discord are all risk considerations. Five distinct types of culture may be identified: controlling, traditional, performance, networks, and integral.
4. Human or Human Capital Components—The value side includes internal qualities such as Intelligence Quotient (“IQ”), Emotional Quotient (“EQ’), creativity, integrity, attitudes, values, passion, awareness, and commitment. Fear, unethical behavior, and low confidences are examples of risk considerations.
   User coordinators are typically the CEO, COO, CFO, and/or members of the company's finance team. In order to generate the initial menu of value and risk considerations, user coordinators may utilize market research, risk management, the Human Resource department of the company, sales and service information, and available databases on value and risk. As shown in FIG. 2, method 100 includes choosing company executives and employees, as well as external evaluators (discussed below), to participate at step 106. Typically, user coordinators choose these company officials. As mentioned above, FIG. 1c shows an example of a graphical user interface for entering evaluators into the VRT tool. In step 108 of method 100, selected company executives and employees (“company evaluators”) use the master list menu to identify value and risk considerations for analysis. As shown in FIG. 3, the tab box TB for the Identification tab includes considerations chosen or selected A (in this case, the evaluator is “Gunnar”) and line items that are available for selection B. Line items may also be created and removed. In FIG. 3, the category section CS includes a selection of Financial/System. Consequently, the line items shown in the tab box TB correspond to Financial/System. Furthermore, the line items correspond to the other selections in the category section CS, e.g., “current market cap” and “assets and value.” By clicking on “future market cap,” “liabilities and risk,” or another selection that is not currently shown elected in FIG. 3, the line items may change since they are tied to the categories, whether the item of interest is a value or risk item, and whether the analysis is of current market capitalization or future market capitalization. See, for example, FIGS. 1e-1t.

After the line items are selected by each company evaluator, input is sought from each company evaluator for each line item selected by that company evaluator. As shown in FIG. 2, each company evaluator's input is provided by ranking the line items 110. The company evaluator may assign rankings by, for example, sorting the line items or inputting numbers next to the line items with, for example, a lower number indicating a higher level of importance. As shown in FIG. 2, after company executives and employees identify and rank certain value and risk considerations (such as a top 20 list of values and risks), the average rank for each consideration is then determined 112. The average rank for each consideration is typically determined by adding up all of the company evaluators' rankings for each consideration and dividing by the number of company evaluators.

As shown in FIG. 4, the tab box TB of the Company Consolidation tab is shown having a tabular summary of the rankings for each consideration in the Financial/Value/Current Market Capitalization combination by two company evaluators (identified as 1 and 2) and the average ranking for the company evaluators. These company considerations may be sorted into a numerical ranking of high to low value and risk considerations based on average rank. This represents the company perspective of value drivers and risk creators.

The considerations selected by the company evaluators are combined together with random value and risk considerations and then are provided to selected external evaluators for their evaluation. It should be noted that external evaluators normally are individuals that are outside of the company, such as, for example, customers, suppliers, bankers, end users, and investors, among others. As noted above, typically, external evaluators are selected to participate to identify and rank considerations by user coordinators.

In step 114 of method 100, each external evaluator identifies value and risk considerations based on whether the external evaluator believes that consideration has an impact on the company. In step 116 of method 100, each external evaluator ranks the identified value and risk considerations based on the external evaluator's perspective of the relative impact of that consideration on the company. For confidentiality purposes, financial information, apart from the list of values and risks, are withheld from the external evaluators. As shown in FIG. 2, upon completion of external evaluator ranking, the average rank for each consideration by external evaluators is then determined 118. As noted above, the average rank for each consideration is typically determined by adding up the evaluators' rankings for each consideration and dividing by the total number of evaluators. These external evaluator rankings may then be tabulated and sorted into a numerical ranking of high to low value and risk considerations based on average rank.

As shown in FIG. 2, by averaging the company and external evaluator average rankings together, a combined (average) rank is determined for each consideration 120. As shown in FIG. 5a, the tab box TB for the Final Consolidation tab includes a tabular summary of rankings for each consideration in the Financial/Value/Current Market Capitalization combination by the company and external evaluators. In FIG. 5a, the line item Products is shown having an average company ranking of 1.00 and an average external evaluator ranking of 1.33. As shown in FIG. 5a, the VRT tool calculates the combined average rank for Products to be 1.11. The external evaluators are listed as 3, 4, and 5. Of course, there may be more or less than the three external evaluators shown in FIG. 5a.

The finance team or other individuals reviewing and planning for the company may use the company and external evaluator ranking information, such as that displayed in the tab boxes of the Company Consolidation and Final Consolidation tabs, for annual planning, to account for budget variances, goal setting, leadership team alignment, problem solving, resource allocation, and staffing decisions, among other action items.

In step 122 of method 100, using the combined rank of each line item and the predetermined total amount that market capitalization exceeds book value (e.g., $100 million), value amounts are determined for each line item. The values may be determined by using various algorithms that account for the spread between combined rankings. For instance, the algorithm may be the ranking score times the amount market capitalization exceeds book value divided by the total ranking score number. In this algorithm, the lowest ranked consideration will have the highest ranking score for value calculation purposes. That is, if there are four considerations, the consideration with the lowest combined rank will have a ranking score of four and the total ranking score number will be ten (1+2+3+4=10). For example, suppose there were only two considerations, A and B, and the amount that market capitalization exceeded book value was $10. If the combined rank of A was less than the combined rank of B, then the value of A may be computed by multiplying 2 (the ranking score) times $10 and dividing by 3 (the total ranking score number), which equals about $7.77. The value of B may be computed by multiplying 1 (the ranking score) times $10 and dividing by 3 (the total ranking score number), which equals about $3.33. As explained below in regards to FIG. 5b, the values of each consideration may be altered by a user coordinator. For example, as shown in FIG. 5a, the values have been adjusted such that the value associated with the company's “Products” is responsible for approximately $27.78 million of the $100 million by which market capitalization exceeds book value. Similarly, the value associated with the company's “Services” is responsible for approximately $13.54 million of the $100 million by which market capitalization exceeds book value.

In step 124 of method 100, the VRT tool generates various reports, charts, and the like to assist users (e.g., finance department of the company) in evaluating the company and determining next steps for the company. After the rankings and values are populated into the tabular summary of FIG. 5a, a user may select the “Change Values” button to generate the display shown in FIG. 5b. In FIG. 5b, a graphical breakdown of line items according to values is shown. Also, FIG. 5b shows a graphical user interface with a graph of value versus rank. The “Value Sensitivity” switch above the graph may be used to shift the worth of line items. A neutral value sensitivity is the default condition. A positive value sensitivity tends to decrease the range between the highest (“Products”) and lowest (“High employee performance standards”) points on the graph shown in the FIG. 5b. A negative value sensitivity tends to increase the range between the highest (“Products”) and lowest (“High employee performance standards”) points on the graph shown in the FIG. 5b. A user, such as a member of the finance department of the company, may use this graphical tool to experiment with values and attempt to balance the value and risk. The value of each consideration shown in FIGS. 5a and 5b is carried forward into the operations that follow.

The Statement of Current Market Capitalization™ of the Report tab shown in FIG. 6 combines the book value from the company balance sheet with the value and risk considerations ranked to explain the difference between book value and current market capitalization. This report quantifies in a single document considerations driving the market capitalization of the company. This report, together with the reports of the Balance Report tab (or “Cockpit”) and the Gap Report tab (both discussed below), may be distributed, for example, to a leadership team of a company in a facilitated meeting. As shown in the Statement of Market Capitalization™ of FIG. 6, the market capitalization of the company is calculated as the net value/risk (labeled NVR) minus the book value (labeled BV), The tab box TB of the Report tab also shows the results of the total assets and total liabilities (book value) and total value and total risk (net value/risk) as calculated by the VRT tool. It should be noted that by selecting the “Future Market Cap” button in FIG. 6 a report is generated regarding future market capitalization.

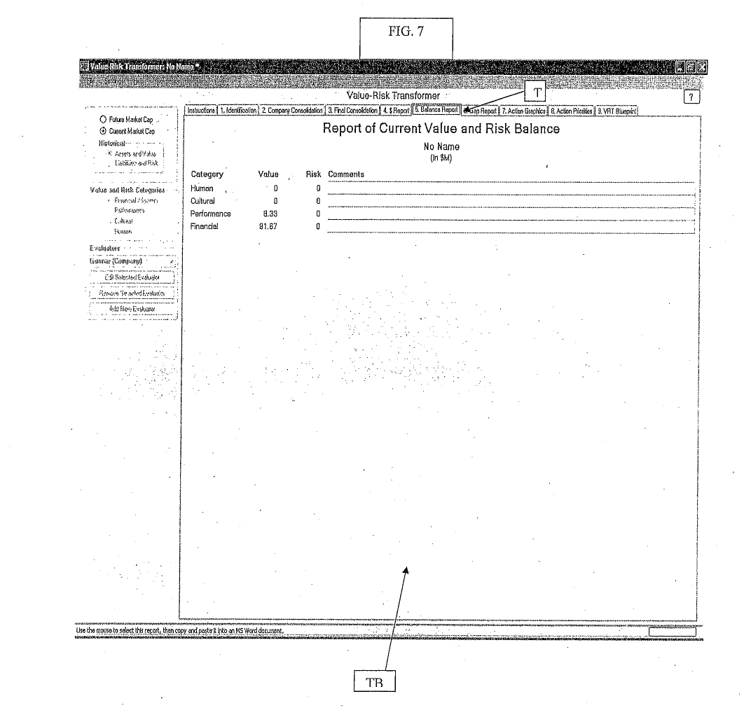

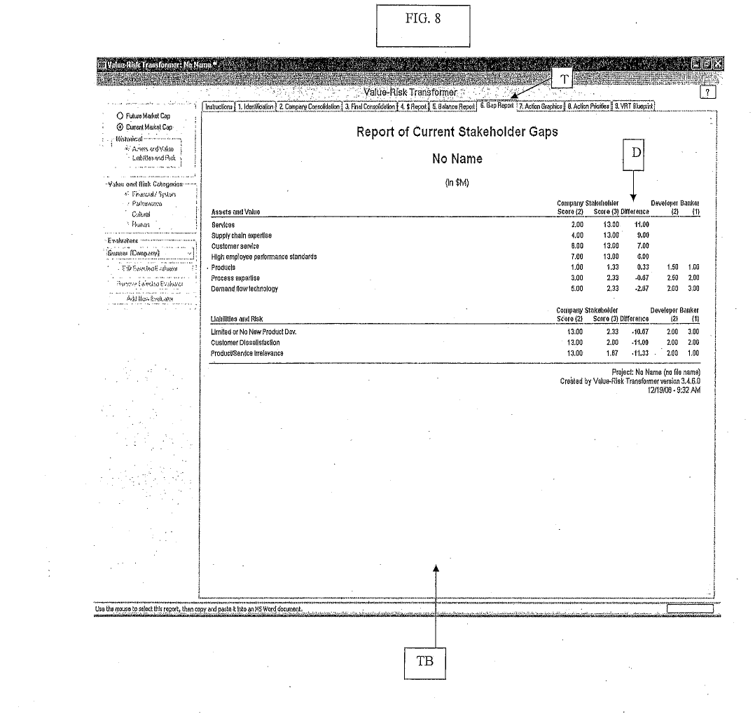

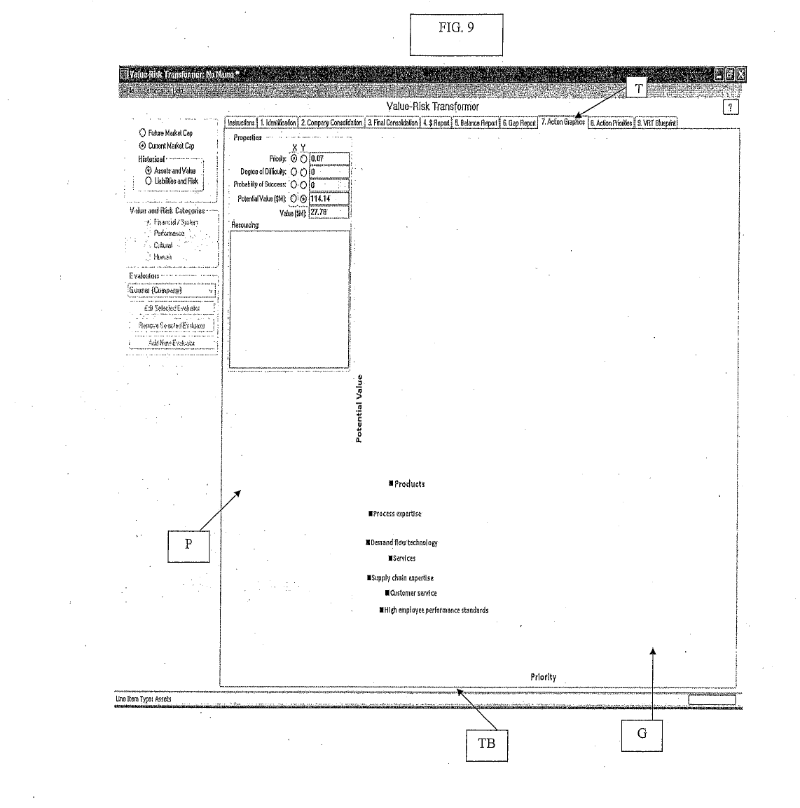

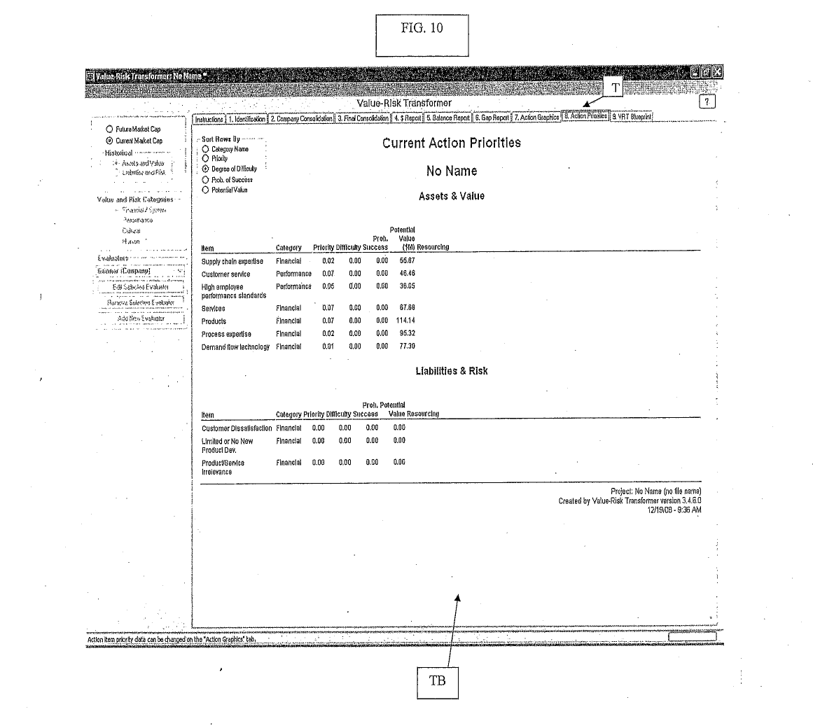

The Cockpit is an advanced, interactive executive dashboard that compares the relative and absolute balance of value and risk in each category and between each category. As such, the Cockpit is a shortcut to locating value and risk issues. When the categories are out of balance, performance and results may decline and value may not be created on a sustainable basis. In other words, sustainable success generally requires a certain balance between and among categories. As shown in FIG. 7, the tab box TB for the Cockpit includes values and risks for the four categories: financial/system, performance, cultural, and human. Using the Cockpit and other parts of this tool, a user may determine what assets, value items, or the like may lead to value growth and what liabilities and/or underperforming asset, etc. may be risks.

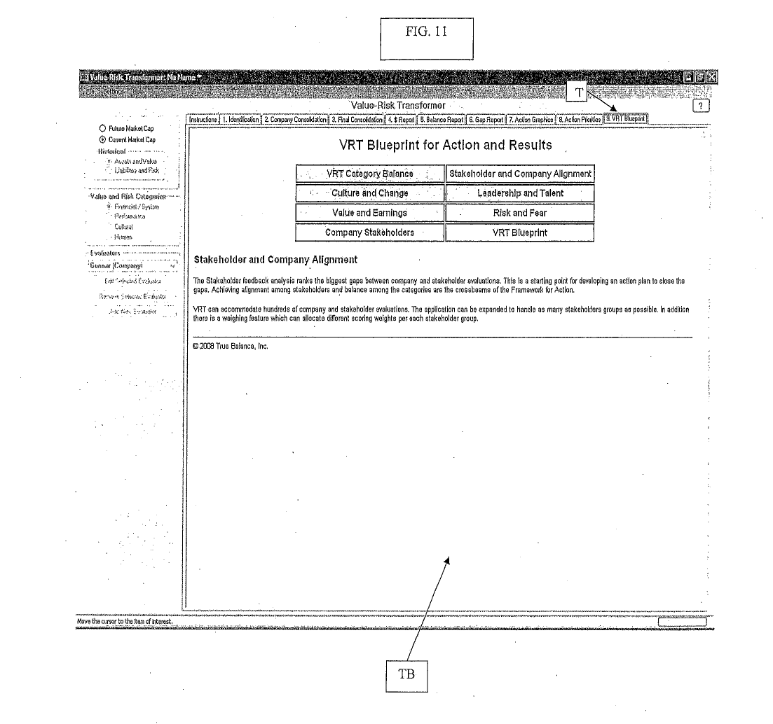

The tab box TB of the Gap Report tab includes comparison data of the rankings from each external evaluator (or external evaluator group) in order to reveal both gaps and alignment for the key sources of value or risk as perceived by the company evaluators and the external evaluators. In FIG. 8, a tabular display of the line items is shown in the tab box TB of the Gap Report tab with corresponding rankings for the company and each external evaluator. The difference D between the two rankings for each line item is calculated and displayed. By closing the gaps and creating alignment between the rankings of the company and external evaluator, there may be an increase in the probability of successful transformation and increased market capitalization.

The finance team or other individuals reviewing and planning for the company may use the company and external evaluator ranking information, such as that displayed in the tab boxes of the Company Consolidation and Final Consolidation tabs, and the valuation and report information, such as that displayed in the tab boxes of the Valuation, Report, Cockpit, and Gap Report tabs, for investigating business alliances, creating business models, improving customer collaboration and customer service, ensuring an effective work force, encouraging innovation, leadership development, developing new market strategies and new product strategies, generating revenue models, talent management, and technology enablement, among other action items.

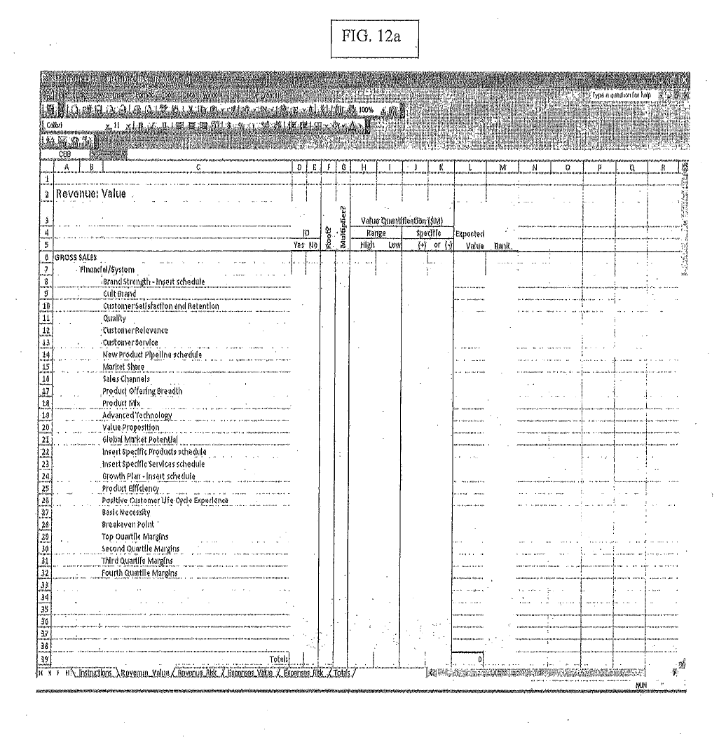

As shown in the tab box TB of the Action Graphics tab in FIG. 9, each value and risk may be plotted and assessed based on constraints, such as priority, degree of difficulty, probability of success and potential value. A user may select two of these constraints in the properties section P of the tab box TB as axes for the graph G. In FIG. 9, the graph G shows line items plotted as priority versus potential value. A user may move the line items displayed in the graph G by dragging an icon representing the line item within the graph. By moving the line item icon, the priority and potential value changes for that line item. A user selecting the “Assets and Value,” “Liabilities and Risks,” “Current Market Cap,” or “Future Market Cap” buttons in FIG. 9 generates similar graphical reports as that shown in FIG. 9, but in each case based on the considerations selected for analysis in those contexts.

In the tab box TB of the Action Priorities tab in FIG. 10, a tabular display of the prioritization, degree of difficulty, probability of success and potential value of each value and risk item is shown. These subjective categories may be used to provide further insights into the value and risk facing a company, and how value can be enhanced and risk can be mitigated.

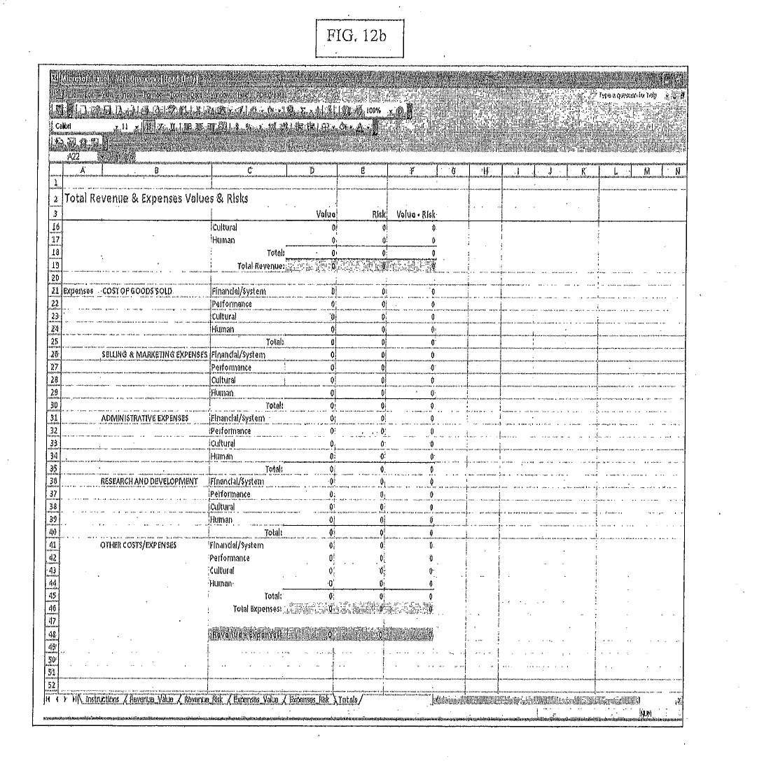

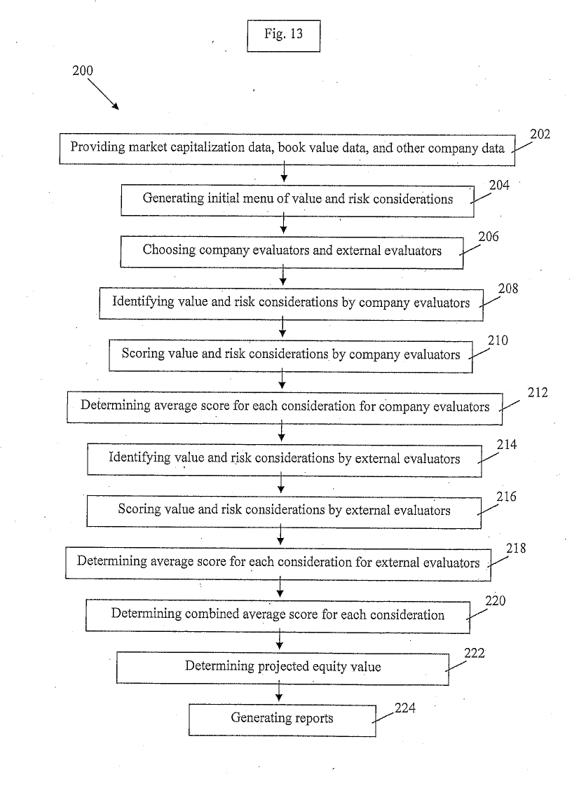

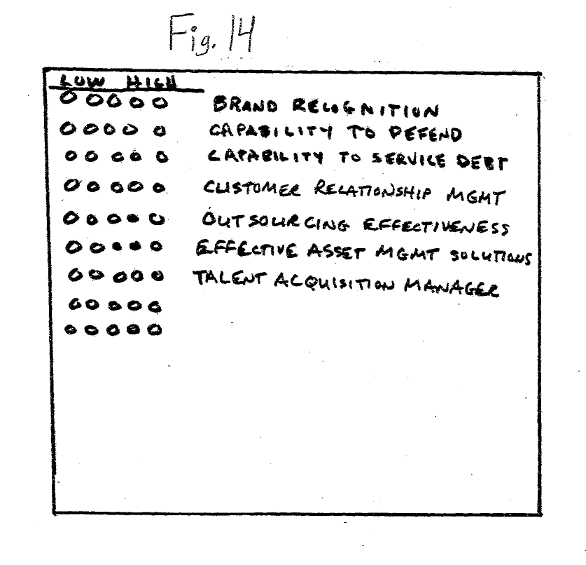

The tab box TB of the Framework tab includes resources relevant to the VRT tool that may be helpful to a user. For instance, in the tab box TB of Framework tab shown in FIG. 11, Stakeholder and Company Alignment provides information on how the input from company officials and external evaluators may be used to develop an action plan for a company. Also, in the tab box TB of FIG. 11, the P&L Deep Dive selection provides reports describing revenue and expenses in terms of value and risk that may also be useful in developing an action plan for a company. FIGS. 12a and 12b show examples of spreadsheets displayed by the P&L Deep Dive selection.

The finance team or other individuals reviewing and planning for the company may use the company and external evaluator ranking information, such as that displayed in the tab boxes of the Company Consolidation and Final Consolidation tabs, the valuation and report information, such as that displayed in the tab boxes of the Valuation, Report, Cockpit, and Gap Report tabs, and the information provided in the tab boxes of the Action Graphics, Action Priorities, and Framework tabs for portfolio management, process improvement, risk mitigation, strategic planning, and for investigating acquisitions, asset sales, management changes, IP investments, changes in structure of the company, system upgrades, and turnarounds, among other action items.

The same series of steps as used for a Current Market Capitalization may be repeated to establish a Future Market Capitalization, except that Current Market Capitalization may be used as the starting point instead of book value. In addition, sources of future value and risk may be pinpointed by using the VRT tool. It should be further noted that every iteration of using the VRT tool may add greater clarity and precision to determining the intrinsic and potential value of the company.

### Valuation of Market Equity

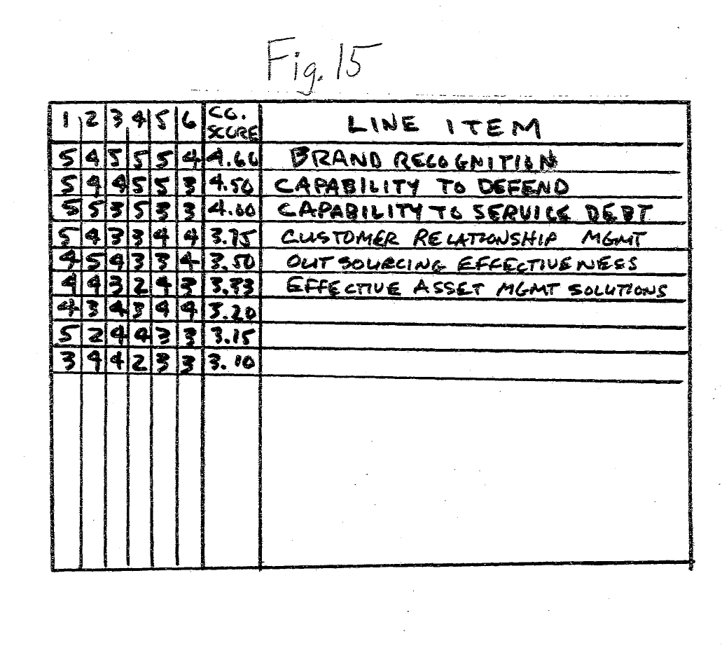

By definition, a private company does not have a market capitalization. However, a private company may still be valued. A VRT tool according to an embodiment of the present disclosure determines the valuation of market equity of a private company, through the analysis of certain value and risk considerations. In one embodiment of the present disclosure, a VRT tool is configured to perform the method for determining the valuation of market equity of a company 200 shown in FIG. 13. As shown in FIG. 13, the method 200 includes providing book value data and other information of the company as step 202. As mentioned above, FIGS. 1b and 1d exemplify graphical user interfaces for inputting information on the company into the VRT tool.

The next step of method 200 is generating an initial menu of value and risk considerations 204. According to the present disclosure, typically one or more user coordinators generates an initial menu of value and risk considerations drawn from the four distinct yet interdependent categories: Financial/System, Performance, Culture, and Human. User coordinators are typically the CEO, COO, CFO, and/or members of the company's finance team. As shown in FIG. 13, method 200 includes choosing company executives and employees and external evaluators to participate at step 206. Typically, user coordinators choose these company officials for participation in scoring the considerations. In step 208 of method 200, selected company executives and employees (“company evaluators”) use the master list menu to identify value and risk considerations for analysis. Referring back to FIG. 3, the tab box TB for the Identification tab includes considerations or line items chosen or selected A and line items that are available for selection B. Line items may also be created and removed. In FIG. 3, the category section CS includes a selection of Financial/System. Consequently, the line items shown in the tab box TB correspond to Financial/System. Furthermore, the line items correspond to the other selections in the category section CS, namely “current market cap” and “assets and value.”

As shown in FIG. 13, after the line items are selected by each company evaluator, each company evaluator scores each line item selected by that company evaluator 210. Each company evaluator's input is provided in the form of a score with, for example, a higher number indicating a higher level of importance. For example, as shown in FIG. 14, after the considerations are selected, each consideration may be aligned with radio buttons along a row representing low to high value. By selecting a particular radio button, the executives and employees of the company effectively choose a score (e.g., between 1 and 5) for the corresponding value or risk consideration. As shown in FIG. 13, after company executives and employees identify and score certain value and risk considerations for one or more categories, the average score for each consideration is then determined at step 212. The average score for each consideration is typically determined by adding up the evaluators' scores for each consideration and dividing by the total number of evaluators.

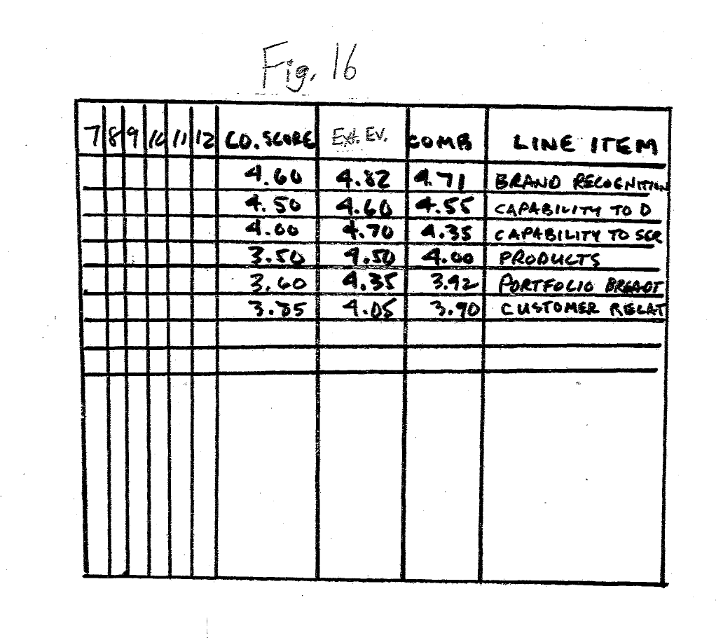

The tab box TB of the Company Consolidation tab includes a tabular summary of the scoring for each consideration by various company evaluators and the average score by the company evaluators. These company considerations may be sorted into a numerical order of high to low value and risk considerations based on average score. This represents the company perspective of value drivers and risk creators. See, for example, FIG. 15.

The company considerations that are combined together with random value and risk considerations then are provided to selected external evaluators for evaluation. It should be noted that external evaluators are individuals that are outside of the company, such as, for example, customers, suppliers, bankers, end users, and investors, among others. Typically, external evaluators are selected to participate by user coordinators.

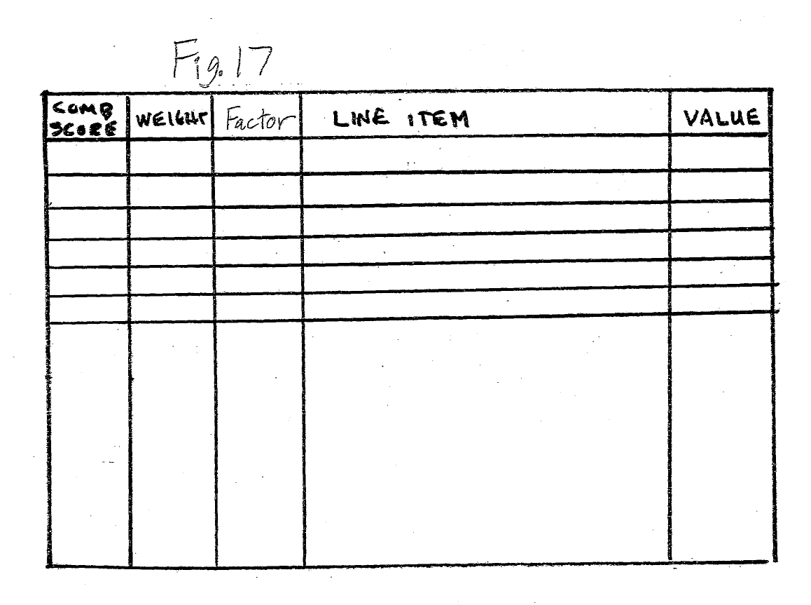

Each external evaluator identifies value and risk considerations 214 in the same way that the company evaluators identify considerations. As shown in FIG. 13, after identifying the considerations, external evaluators then score each consideration 216. The external evaluators may score the considerations in various ways. For example, as described above in FIG. 14 for company evaluators, each external evaluator may select a radio button that represents a score between 1 and 5. For confidentiality purposes, financial information, apart from the list of values and risks, are withheld from the external evaluators. As shown in FIG. 13, upon completion of external evaluator scoring, the scores for each consideration are averaged together to provide an average score for each consideration by all external evaluators at step 218. Upon completion of company and external evaluator scoring, the average scores for the company and external evaluator, respectively, are averaged together to provide a combined average score for each consideration at step 220. As shown in FIG. 16, the tab box TB for the Final Consolidation tab can include a tabular summary of scores for each consideration by the company and external evaluators, as well as the average scores for each and the combined average score.

The finance team or other individuals reviewing and planning for the company may use the company and external evaluator scoring information, such as that displayed in the tab boxes of the Company Consolidation and Final Consolidation tabs, for annual planning, to account for budget variances, goal setting, leadership team alignment, problem solving, resource allocation, and staffing decisions, among other action items.

It should be noted that the “double evaluation” (identification and scoring) by evaluators may provide for a check on evaluators. For instance, if an evaluator determined that a particular consideration should be identified for analysis but only chose a 1, 2, or 3 for a score, then a warning may be issued or an error may be triggered indicating that the evaluator has made a mistake.

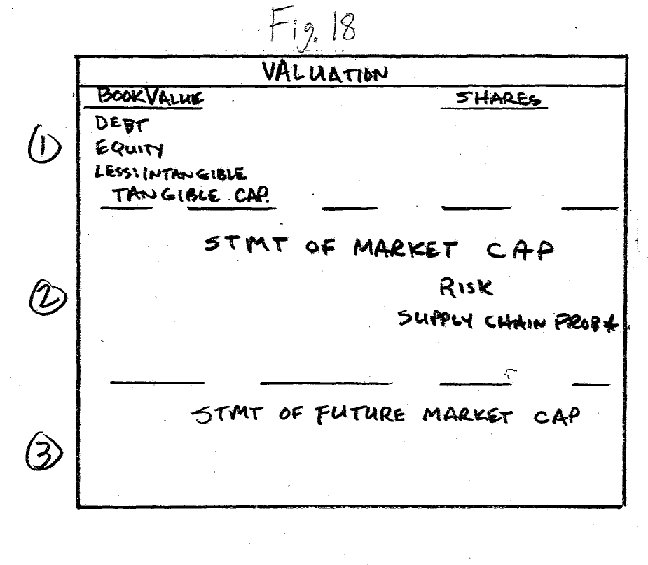

The combined evaluation from company and external evaluators is valued by projecting a company valuation based off book value. In particular, the total tangible capital of the company is multiplied by a weight and a factor of each respective value and risk consideration to produce a dollar amount for each of the value and risk considerations. The total tangible capital of the company is determined by adding the debt and equity of the company and subtracting the intangible assets of the company. The amounts allotted to debt, equity, and intangible assets of the company may be supplied by the finance department, market research team, or other entity of the company. The value and risk considerations of each category (e.g., Financial, Performance, Human, or Cultural) are typically assigned a particular weight. For example, for value considerations, Financial may be assigned 50%, Performance may be assigned 20%, Human may be assigned 15%, and Cultural may be assigned 15%. For risk considerations, Financial may be assigned −25%, Performance may be assigned −20%, Human may be assigned −10%, and Cultural may be assigned 0%. The assignment of weights typically includes reviewing historical records for the company or similar companies to determine how value and risk for each category has fared in the past. The weights may be set under user preferences of the Settings pull down menu of the VRT tool. The algorithm, which provides the factor, may include user selected numbers based on a scoring range. For example, if the combined average score of the line item is 4.0 or above, the factor may be 0.7. If the combined average score of the line item is between 3.0 and 4.0, the factor may be 0.4. If the score of the line item is less than 3.0, the factor may be −0.4. In another example, if the combined average score of the line item is between 4.0 and 5.0, the factor may be 0.8. If the combined average score is less than 4.0 and more than or equal to 3.0, the factor may be 0.4. If the combined average score is less than 3.0 and more than or equal to 2.5, the factor may be 0.00. If the combined average score is less than 2.5 and more than or equal to 1.75, the factor may be −0.25. Finally, if the combined average score is less than 1.75, the factor may be −0.50. At least in part, the factor is included to provide a better estimation of value. Typically, the factor values may be the same for similarly situated companies. In some cases, the factor values may be changed based upon information collected by one or more companies over time. After multiplying the total tangible capital by the weight and factor for each value and risk consideration for each category, the totals for each consideration are combined to produce the total adjustments to value. As shown in FIG. 17, the combined average scores, weights, factors, and values may be presented in a text box TB of the Report tab. The total adjustments to value amount is added to the total tangible capital, subtracting the debt from this sum, and adding intangible assets to provide the projected equity value for the company at step 222.

The VRT tool produces at least three reports 224 based off of method 200. First, the Statement of Projected Company Valuation™ is generated. This statement shows the value and risk together with associated dollar amounts. See, for example, section (1) of FIG. 18. It should be noted that sections (2) and (3) of FIG. 18 related to the Statement of Market Capitalization™ and Statement of Future Market Capitalization™ that are generated when determining sources of value and risk (described above).

Second, the Cockpit sorts the valuation information into the four categories of financial/systems, performance, cultural, and human to reveal the distribution of value/risk and potential imbalance. The Cockpit compares the relative and absolute balance of value and risk in each category and between each category. As such, the balance report is a shortcut to locating value and risk issues. When the categories are out of balance, performance and results may decline and value may not be created on a sustainable basis. In other words, sustainable success generally requires a certain balance between and among categories. Using the balance report and other parts of this tool, a user may determine what assets, value items, or the like may lead to value growth and what assets, value items, etc. may be risks to value growth. The Cockpit also generates a summary reconciliation of book value to projected company value. This summary reconciliation report is also formatted based on the four categories of financial/systems, performance, cultural, and human.

Third, the Gap Report tab includes comparing the scoring from each external evaluator (or external evaluator group) in order to reveal both gaps and alignment for the key sources of value or risk as perceived by the company evaluators and the external evaluators. By closing the gaps and creating alignment between the scores of the company and external evaluator, there may be an increase in the probability of successful transformation and increased market equity.

The finance team or other individuals reviewing and planning for the company may use the company and external evaluator scoring information, such as that displayed in the tab boxes of the Company Consolidation and Final Consolidation tabs, and the valuation and report information, such as that displayed in the tab boxes of the Valuation, Report, Cockpit, and Gap Report tabs, for investigating business alliances, creating business models, improving customer collaboration and customer service, ensuring an effective work force, encouraging innovation, leadership development, developing new market strategies and new product strategies, generating revenue models, talent management, and technology enablement, among other action items.

As shown in the tab box TB of the Action Graphics tab in FIG. 9, each value and risk may be plotted and assessed based on constraints, such as priority, degree of difficulty, probability of success and potential value. A user may select two of these constraints in the properties section P of the tab box TB as axes for the graph G. In FIG. 9, the graph G shows line items plotted as priority versus potential value. A user may move the line items displayed in the graph G by dragging an icon representing the line item within the graph. By moving the line item icon, the priority and potential value changes for that line item. A user selecting the “Assets and Value,” “Liabilities and Risks,” or other radio buttons in FIG. 9 generates similar graphical reports as that shown in FIG. 9, but in each case based on the considerations selected for analysis in those contexts.

In the tab box TB of the Action Priorities tab in FIG. 10, a tabular display of the prioritization, degree of difficulty, probability of success and potential value of each value and risk item is shown. These subjective categories may be used to provide further insights into the value and risk facing a company, and how value can be enhanced and risk can be mitigated.

The tab box TB of the Framework tab includes resources relevant to the VRT tool that may be helpful to a user. For instance, in the tab box TB of Framework tab shown in FIG. 11, Stakeholder and Company Alignment provides information on how the input from company officials and external evaluators may be used to develop an action plan for a company. Also, in the tab box TB of FIG. 11, the P&L Deep Dive selection provides reports describing revenue and expenses in terms of value and risk that may also be useful in developing an action plan for a company. FIGS. 12a and 12b show examples of spreadsheets displayed by the P&L Deep Dive selection.

The finance team or other individuals reviewing and planning for the company may use the company and external evaluator scoring information, such as that displayed in the tab boxes of the Company Consolidation and Final Consolidation tabs, the valuation and report information, such as that displayed in the tab boxes of the Valuation, Report, Cockpit, and Gap Report tabs, and the information provided in the tab boxes of the Action Graphics, Action Priorities, and Framework tabs for portfolio management, process improvement, risk mitigation, strategic planning, and for investigating acquisitions, asset sales, management changes, IP investments, changes in structure of the company, system upgrades, and turnarounds, among other action items.

As noted above, every iteration of using the VRT tool may add greater clarity and precision to determining the intrinsic and potential value of the company.

A VRT tool according to at least one embodiment of the present disclosure comprises at least one computer, computing device, or system of a type known in the art, such as a mainframe computer, workstation, personal computer, laptop computer, hand-held computer, wireless mobile telephone, personal digital assistant device, and the like.

Each such computer comprises a processor, such as a programmable-variety processor responsive to software instructions, a hardwired state machine, or a combination of these. Each computer also comprises memory, which in conjunction with the processor is used to process data and store information. Such memory can include one or more types of solid state memory, magnetic memory, or optical memory, just to name a few. By way of non-limiting example, the memory can include solid state electronic random access memory (RAM); sequential access memory (SAM), such as first-in, first-out (FIFO) variety or last-in, first-out (LIFO) variety; programmable read only memory (PROM); electronically programmable read only memory (EPROM); or electronically erasable programmable read only memory (EEPROM); an optical disc memory (such as a DVD or CD-ROM); a magnetically encoded hard disc, floppy disc, tape, or cartridge media; or a combination of these memory types. In addition, the memory may be volatile, non-volatile, or a hybrid combination of volatile and non-volatile varieties. The memory may include removable memory, such as, for example, memory in the form of a non-volatile electronic memory unit; an optical memory disk (such as a DVD or CD ROM); a magnetically encoded hard disk, floppy disk, tape, or cartridge media; or a combination of these or other removable memory types.

Each computer also comprises a display upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Each computer also comprises one or more data entry, such as, for example, a keyboard, keypad, pointing device, mouse, touchpad, touchscreen, microphone, and/or other data entry means known in the art. Each computer also may comprise an audio display means such as one or more loudspeakers and/or other means known in the art for emitting an audibly perceptible output.

After being presented with the disclosure herein, one of ordinary skill in the art will realize that embodiments of the present disclosure can be implemented in software, firmware, and/or a combination thereof. Program code according to the present invention can be implemented in any viable programming languages such as Basic, C, C++, .NET, Fortran, JavaScript, Java, Pascal, PERL, HTML, XML, or SQL, or a combination of any of the foregoing or the equivalents thereof or any other viable high-level programming language, or a combination of such a high-level programming language and a low-level programming language such as Assembler, for example.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein and in the appended documents represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

1. A method of analyzing value and risk through the use of one or more computers, the method comprising:
providing market capitalization data and book value data to one or more computers;
identifying a first value list using the one or more computers, the first value list comprising one or more value items;
ranking the value items of the first value list using the one or more computers;
identifying a first risk list using the one or more computers, the first risk list comprising one or more risk items;
ranking the risk items of the first risk list using the one or more computers;
determining the average rank for each of the value items of the first value list and the risk items of the first risk list using the one or more computers;
identifying a second value list using the one or more computers, the second value list comprising one or more value items;
ranking the value items of the second value list using the one or more computers;
identifying a second risk list using the one or more computers, the second risk list comprising one or more risk items;
ranking the risk items of the second risk list using the one or more computers;
determining the average rank for each of the value items of the second value list and the risk items of the second risk list using the one or more computers;
determining the combined average rank for each item ranked using the one or more computers;
determining the value of each item ranked based on the combined average rank for each item and the difference between the market capitalization and the book value using one or more computers; and
displaying at least a portion of the ranking information and the value of each item on the one or more computers.

2. The method of claim 1, wherein identifying the value items of the second value list comprises selecting value items among the first value list and at least one item that is not in the first value list.

3. The method of claim 1, wherein identifying the value items of the first value list comprises entering items into the one or more computers.

4. The method of claim 1, wherein identifying the value items of the first value list comprises selecting at least one item using one or more computers.

5. The method of claim 4, wherein identifying the value items of the second value list comprises selecting at least one item using one or more computers.

6. The method of claim 1, wherein ranking the value items of the first value list comprises ordering the value items from most valuable to least valuable.

7. The method of claim 6, wherein ranking the value items of the second value list comprises ordering the value items from most valuable to least valuable.

8. A method of analyzing value and risk through the use of one or more computers, the method comprising:
providing predetermined weight data and capital data;
identifying a first value list using the one or more computers, the first value list comprising one or more value items;
scoring the value items of the first value list using the one or more computers;
identifying a first risk list using the one or more computers, the first risk list comprising one or more risk items;
scoring the risk items of the first risk list using the one or more computers;
determining the average score for each of the value items of the first value list and the risk items of the first risk list using the one or more computers;
identifying a second value list using the one or more computers, the second value list comprising one or more value items;
scoring the value items of the second value list using the one or more computers;
identifying a second risk list using the one or more computers, the second risk list comprising one or more risk items;
scoring the risk items of the second risk list using the one or more computers;
determining the average score for each of the value items of the second value list and the risk items of the second risk list using the one or more computers;
determining the combined average score for each item scored using the one or more computers;
determining the contribution to tangible capital by at least one scored item based on the predetermined weight data, a factor that is based on the combined average score of the at least one scored item, and the capital data of the company using the one or more computers; and
displaying at least a portion of the score information on the one or more computers.

9. The method of claim 8, wherein identifying the value items of the second value list comprises selecting at least one item from the first value list and at least one item that is not in the first value list.

10. The method of claim 8, wherein identifying the value items of the first value list comprises entering at least one item into the one or more computers.

11. The method of claim 8, wherein identifying the value items of the first value list comprises selecting at least one item using one or more computers.

12. The method of claim 11, wherein identifying the value items of the second value list comprises selecting at least one item using one or more computers.

13. The method of claim 8, wherein scoring the value items of the first value list comprises selecting a number within a predetermined range.

14. The method of claim 13, wherein scoring the value items of the second value list comprises selecting a number within the predetermined range.

15. The method of claim 8, wherein the factor comprises four values corresponding to four different numerical ranges.

16. A computer-readable program for analyzing value and risk, the computer-readable program comprising code portions stored therein, the computer-readable program code portions comprising:
a first executable portion for receiving predetermined weight data and tangible capital data;
a second executable portion for identifying a first value list, the first value list comprising one or more value items, wherein the second executable portion is also configured for scoring the value items of the first value list, wherein the second executable portion is further configured for identifying a first risk list, the first risk list comprising one or more risk items, wherein the second executable portion is further configured for scoring the risk items of the first risk list, wherein the second executable portion is further configured for determining the average score for each of the value items of the first value list and the risk items of the first risk list;
a third executable portion for identifying a second value list, the second value list comprising one or more value items, wherein the third executable portion is also configured for scoring the value items of the second value list, wherein the third executable portion is further configured for identifying a second risk list, the second risk list comprising one or more risk items, wherein the third executable portion is further configured for scoring the risk items of the second risk list, wherein the third executable portion is further configured for determining the average score for each of the value items of the second value list and the risk items of the second risk list;
a fourth executable portion for determining the combined average score for each item scored;
a fifth executable portion for determining the contribution to tangible capital by at least one scored item based on the predetermined weight data, a factor that is based on the combined average score of the at least one scored item, and the capital data of the company; and
a sixth executable portion for displaying at least a portion of the score information.

17. The computer-readable program of claim 16, wherein the first executable portion is also configured for receiving market capitalization data and book value data.

18. The computer-readable program of claim 17, wherein the second executable portion is further configured for identifying a first value list, the first value list comprising one or more value items, ranking the value items of the first value list, identifying a first risk list, the first risk list comprising one or more risk items, ranking the risk items of the first risk list, and determining the average rank for each of the value items of the first value list and the risk items of the first risk list.

19. The computer-readable program of claim 18, wherein the third executable portion is further configured for identifying a second value list, the second value list comprising one or more value items, ranking the value items of the second value list, identifying a second risk list, the second risk list comprising one or more risk items, ranking the risk items of the second risk list, and determining the average rank for each of the value items of the second value list and the risk items of the second risk list.

20. The computer-readable program of claim 19, wherein the fourth executable portion is further configured for determining the combined average rank for each item ranked, wherein the fifth executable portion is further configured for determining the value of each item ranked based on the combined average rank for each item and the difference between the market capitalization and the book value, and wherein the sixth executable portion is further configured for displaying at least a portion of the ranking information and the value of each item.
